(19) United States
(12) Patent Application Publication
(10) Pub. No.: US 2005/0198156 A1
(43) Pub. Date: Sep. 8, 2005

(54) Method of handling message communication between network entities

(76) Inventor: Eric Cheng, Naperville, IL (US)

Correspondence Address: CARLSON, GASKEY & OLDS, P.C., 400 WEST MAPLE ROAD, SUITE 350, BIRMINGHAM, MI, 48009, US

(21) Appl. No.: 10/792,588

(22) Filed: Mar. 3, 2004

(51) Int. Cl. G06F 15/16

(52) U.S. Cl. 709/206

(57) ABSTRACT

A method of handling problematic message communications between network entities includes modifying a completed, generated message before it is processed by an intended recipient. A message modifier, which is a software module in one example, is incorporated into a communication system so that the message modifier can modify messages without requiring the message generator or receiver to be modified. The message modifier in one example can be trained or programmed to recognize a specific type of message based on selected criteria and to automatically modify an identified parameter in that type of message whenever one is sent or received, depending on the particular situation. In a disclosed example, the message modifier is a software module incorporated into a switching center.

### FIELD OF THE INVENTION

This invention generally relates to handling messages in inter-system communications. More particularly, this invention relates to modifying generated messages in inter-system communications.

### DESCRIPTION OF THE RELATED ART

Modern communication systems may be wireless or land based. In the wireless industry, in particular, there is a need for various messages to be sent that facilitate communications between different service providers or equipment provided by different suppliers. Communication standards have been established to facilitate such communications. It is necessary for messages sent within such systems to conform to the standard so that the proper information is conveyed.

With the introduction of new technologies and new standards, it is necessary to determine whether messages sent in such situations convey accurate information according to accepted standards. Typically, more than one supplier or vendor will participate in compatibility testing between their respective communication devices that will operate under a given standard. Such testing reveals when there are difficulties or errors in messages so that such situations can be addressed before the new technologies are introduced for subscriber use.

It is common, for example, that the design of inter-system messages such as those used in the ISUP, IS-41 or IS-826 protocols, are different in two telecommunication network entities. Such design differences can cause failures in communication between the entities. To address such a situation, the common practice is to suspend compatibility testing so that the entity responsible for the error can make appropriate adjustments to the message sending device or software or the receiving device or software, depending on the particular situation.

While this approach eventually resolves differences and establishes effective communications for most circumstances under a selected protocol, there is a major drawback to suspending the compatibility testing. Redesigning the appropriate portions of the involved device or software typically takes at least several days; a time during which compatibility testing cannot be continued. When more than one entity has an error at any time, all of the entities involved in the testing must wait until that error is corrected before testing continues.

There is a need for an approach that would allow for continued testing even though message communication errors occur in communications between different entities. Such an approach would allow compatibility testing to be carried out more efficiently and effectively.

Further, during actual communications between subscribers, it is possible for different entities' technologies to have communication errors when their respective devices are communicating. It is desirable to provide the ability to address such situations without interrupting service to the subscriber of either entity.

This invention addresses such needs by providing the ability to modify incorrect messages in a manner that allows communications to continue because it does not require altering the message generating or receiving devices.

### SUMMARY OF THE INVENTION

In general terms, this invention is a method of modifying completed, generated messages within a switching center before they are processed by an intended recipient.

One example method includes determining when an error occurs in an identified type of message from a particular message generator. Before such a message is transmitted to another destination, that message is modified after it has been generated. The modification to the message may include changing at least one parameter of the message to make it consistent with the appropriate standard. At a later time, the message generator can be modified so that the message modification will no longer be necessary and the communication under the selected standard occurs as desired.

In another example, when a message is transmitted by a source in a correct format but the receiver that processes such messages needs modification to properly interpret that message, that message can be modified so that the receiver, in its current state, interprets the message as if the receiver were functioning correctly. At a later time, the receiver can be modified so that the message modification will no longer be necessary and the communication under the selected standard occurs as desired.

In one example, a message modifier comprises a software module that is added onto a switching center. The message modifier is capable of recognizing selected types of messages and correcting identified errors in such messages in a manner that facilitates continued communication between different entities sending and receiving such messages.

The disclosed example methods allow for continued communications among network entities where there are message incompatibles so that a correction to the appropriate portion of the system can be made to ultimately correct the system error. The intermediate message correction provided by the disclosed examples facilitates compatibility testing and subscriber communications, depending on the particular application.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates selected portions of a communication system having the capability of modifying messages according to an embodiment of this invention.

FIG. 2 schematically illustrates a data field of one example embodiment of this invention.

### DETAILED DESCRIPTION

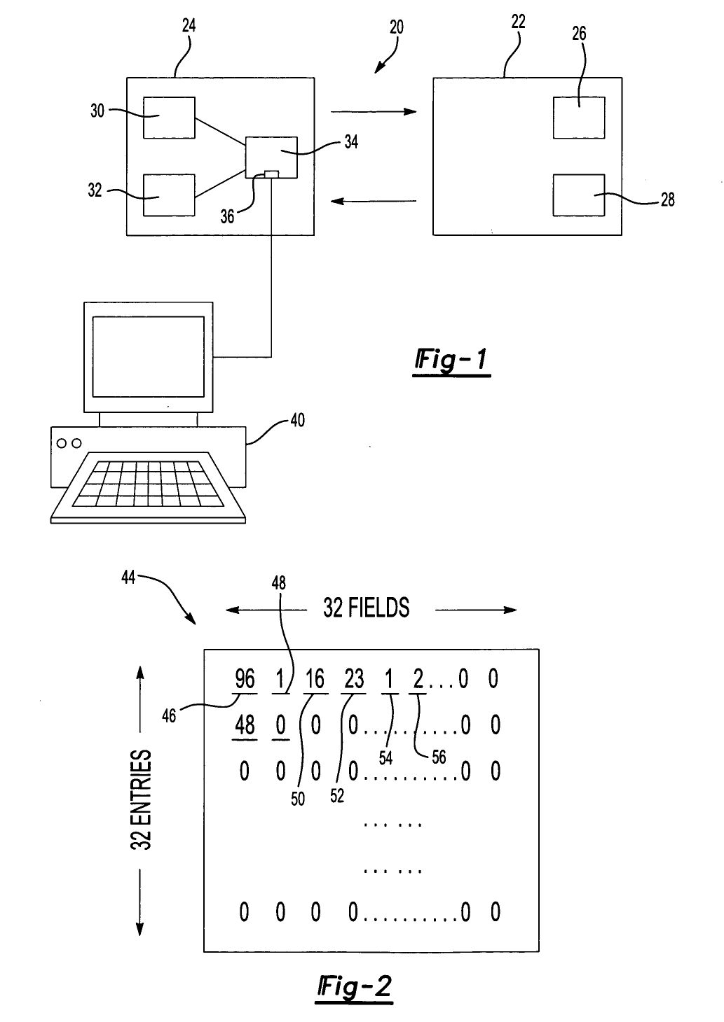

FIG. 1 schematically shows a communication system 20. Different network entities have communication devices 22 and 24. In one example, the devices 22 and 24 comprise switching centers. The communication devices 22 and 24 may facilitate wireless communications, land-based communications or some combination of them. In the illustrated example and for the remainder of this discussion, it will be assumed that the communications between the devices 22 and 24 are wireless.

The communication device 22 includes a message generator portion 26 and a message receiver portion 28. Messages sent between the devices 22 and 24 facilitate communications in known ways. For example, the message generator 26 may generate a registration notification message. The communication device 24 includes a message receiver portion 30 that ultimately receives the registration notification message and interprets it in a known manner to facilitate further communications as needed. The device 24 also includes a message generator portion 32 that similarly generates known messages in a known manner. In one example, the communication devices 22 and 24 are switching centers.

In the illustration, the communication device 24 includes a message modifier 34 that processes all completed incoming and outgoing messages to the communication device 24. A completed message in this document is one that is generated and ready for transmission to another network entity. Although not specifically illustrated, the communication device 22 may also include a message modifier. The message modifier 34 in one example comprises a software module added onto the switching center platform. In this example, no modification of the message receiver 30 or message generator 32 is required and the message modifier 34 facilitates message communication between the devices 22 and 24 even when one or more message types or a portion of a device does not conform to a protocol standard or otherwise contains errors that prevent effective communication between the devices 22 and 24.

There are a variety of types of messages that are known and sent between entities in such communications. The message modifier 34 is capable of recognizing any type of message and effectively capturing such a message before it is communicated to an intended destination. In the illustrated example, a message incoming to the device 24 could be trapped and modified by the message modifier 34 before being presented to the receiver 30. Similarly, the message modifier 34 may be used to modify a message generated by the message generator 32 before such a message is transmitted to another location such as the communication device 22. The message modifier 34, therefore, is useful for bi-directional communications.

In some situations, the message is incorrect because the message content is not consistent with the given standard. In other situations, the message content may be correct but a device involved in the processing of the message is not functioning properly resulting in an error. In either situation, the message modifier 34 can make modifications to a generated message so that communication continues as if the message were generated correctly or the erroneous device is functioning properly, depending on the situation.

For example, the message generator 26 may provide registration notification messages that include an incorrect parameter. Prior to this invention, such a message would not be interpretable by the message receiver 30. Accordingly, such communication could not continue between the devices. During compatibility testing, according to old practices the vendor using the message generator 26 would have to determine the source of the error and then redesign the message generator or the appropriate portion of software so that the registration notification messages are sent in a correct format.

With the illustrated embodiment, the message modifier 34 is trainable to detect when such a message is sent from the device 22 to the device 24. When such a message is received, the message modifier 34 corrects the incorrect parameter before it is provided to the receiver 30 for processing. Accordingly, the message generated by the message generator 26 is corrected before the receiver 30 receives it for processing. Such a correction allows for continued communications between the devices even though the message had an error within it.

In the illustrated example, the message modifier 34 includes a user interface portion 36 that allows for communication between a user interface device 40 and the message modifier 34. In the illustrated example, the user interface device 40 is a laptop computer. Various known devices can be used for this purpose.

The user interface 36 allows an individual to communicate with the message modifier 34 in a manner that the individual is able to determine the type of message that is presenting a problem. Further, the individual technician is allowed to determine what is the problem associated with that type of message. The individual can then convey such information to the message modifier 34 using known techniques such that the message modifier 34 becomes trained or programmed to recognize such messages in the future and to automatically modify such messages. This allows for continued communications without having to stop so that the message generator 26 can be corrected.

Of course, the message generator 26 later can be corrected for future use and the information obtained using the message modifier 34 and the user interface 36 preferably is provided to the vendor of the message generator 26 so that appropriate corrective action is taken. Such a correction need not be done immediately and can be done at a later date because the communications between the devices 22 and 24, such as during compatibility testing for example, may continue because of the operation of the message modifier 34.

A technician using the interface device 40 and the user interface 36 effectively describes a scenario that describes a type of message and type of correction to be made by the message modifier 34. When a message from a particular vendor, for example, always contains an error, the message modifier 34 may correct all messages from that vendor. When a particular kind of message from a particular vendor has errors within it, the message modifier can be trained to recognize a plurality of criteria that must be met before a message will be modified to make an appropriate correction. In one example, when more than one criteria is set for correcting a message, all of the set criteria must be met before the message modifier 34 will take corrective action on a message.

One example message modifier 34 has the capability of doing at least one of the following modifications. The message modifier 34 may drop a parameter in all incoming or outgoing messages. The message modifier 34 may drop a parameter for messages sent to a specific destination. The message modifier 34 may also modify a selected parameter based upon a parameter identification in all incoming or outgoing messages. The message modifier 34 may modify a parameter by a parameter identification for a specific type of incoming or outgoing message such as an IS-41 operation message. The message modifier 34 may also correct only a portion of a parameter, depending on the particular type of message that requires modification.

A message modifier designed according to an embodiment of this invention can be a software module that is added on to all system sites for effective communications. One example message modifier 34 may be used at any time and is not just limited to compatibility testing. The message modifier 34 provides an effective means for identifying multiple problems for a variety of call scenarios. The message modifier 34 effectively has no impact on the system software or the system performance and does not depend on another vendor's equipment development effort or schedule. No additional hardware or equipment cost is incurred when a message modifier 34 designed according to an embodiment of this invention is incorporated into at least one of the communicating devices within a system such as the example of FIG. 1.

As mentioned above, one example embodiment is a software module message modifier 34. In this example, there is an internal memory associated with the software package that controls the action requested for correcting a particular parameter, for example, within a selected type of message. FIG. 2 schematically illustrates a data file for controlling the actions of the message modifier 34 for one example implementation. In FIG. 2, the data file 44 contains a 32×32 array of shorts and totals 2K bytes. Each row in the file 44 describes how a parameter is to be trapped and modified. The message modifier 34 includes programming that enables it to read the file 44 and respond in an appropriate manner. An individual such as a technician can update the table 44 based on message modification needs using the input device 40 and then download such information to have the appropriate trap and modify function carried out by the message modifier 34.

Each row of the table 44 includes information for how the message modifier 34 is to trap and modify a parameter or portion of a parameter, depending on the corrective action that is required. The data in a row of this example includes at least five parts. A parameter control is indicated by the first two bytes shown at 46. The parameter control specifies a parameter identification (i.e., nature of number).

The next entry shown at 48 is a control field. In this example, the number 1 in the control field means to trap and modify an incoming message in this example.

The next item shown at 50 is a destination identifier, which in this example indicates when the incoming message comes from a source identified by the value stored at 50, the message should be trapped and modified by the message modifier 34.

The next item shown at 52 is a message identifier indicating the type of message that should be corrected. In one example, the numbers 23 indicate a registration notification message. Accordingly, when the parameter, control field, destination and message identifier information of an incoming message correspond to those shown at 46-52, the message modifier 34 is to take corrective action.

In this example, the old value that is to be corrected is shown at 54. The new value is shown at 56. In this example, the value 1 is to be changed to the value 2 and the message modifier 34 is programmed to identify the appropriate parameter and make the change indicated in the data file 44.

Of course, the message modifier 34 can be programmed to do other requested actions for changing or modifying message to suit the needs of a particular situation. Where more than one condition is specified, the message is modified (i.e., a parameter is corrected or dropped) only if all of the conditions are met in this example.

The requested action may be one or more of the following: dropping a parameter in all outgoing messages to all destinations; dropping a parameter in all outgoing messages to a specific destination; dropping a parameter from at least one selected outgoing message; dropping a parameter from selected incoming messages; trapping and modifying a parameter in an outgoing message; or trapping and modifying a parameter in an incoming message.

In the example of FIG. 2, when the “nature of number” in the CPN parameter of a registration notification incoming message through G-link 16 is equal to 1, the message modifier 34 changes that parameter to 2.

A variety of ways of defining how the message modifier 34 is to carry out an intended modification may be used with an example embodiment of this invention. Given this description, those skilled in the art will be able to develop the software code necessary to implement a message modifier that will be compatible with their particular needs in a given situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of handling messages between network entities, comprising:
identifying a completed message within a switching center;
determining whether the identified message requires modification; and
modifying the identified message within the switching center before the message is processed by an intended recipient.

2. The method of claim 1, including at least one of dropping or changing at least one parameter of the generated message.

3. The method of claim 1, including receiving the message by the switching center before modifying the message.

4. The method of claim 1, including modifying the message using the switching center before transmitting the message to an intended recipient remote from the switching center.

5. The method of claim 1, including correcting an incorrect completed message.

6. The method of claim 1, including modifying a correct, completed message to be compatible with a device that does not properly process a correct message.

7. The method of claim 1, including:
identifying at least one type of message that is in need of modification;
identifying at least one parameter to be modified within the identified type of message; and
automatically modifying the identified parameter when a message is of the identified type.

8. The method of claim 7, wherein the identifying steps are performed at least in part by an individual.

9. The method of claim 7, wherein identifying the type of message includes selecting at least one criteria that is indicative of the type of message.

10. The method of claim 9, including selecting a plurality of criteria and automatically modifying the identified parameter for a message that satisfies the entire plurality of criteria.

11. The method of claim 9, including selecting the criteria from the group of criteria including message type, message content, message sender, intended recipient.

12. The method of claim 1, including modifying the message by dropping or changing at least one of:
at least one parameter from all outgoing messages to all destinations;
at least one parameter from all outgoing messages to at least one selected destination;
at least one parameter from at least one selected outgoing message to all destinations;
at least one parameter from at least one selected outgoing message to at least one selected destination;
at least one parameter from all incoming messages from all senders;
at least one parameter from all incoming messages from at least one selected sender;
at least one parameter from at least one selected incoming message from all senders; and
at least one parameter from at least one selected incoming message from at least one selected sender.

13. A switching center device, comprising:
a message generator that generates at least one message to be communicated to a selected destination;
a message receiver that receives at least one message sent from a sender; and
a message modifier within the switching center that automatically modifies a message after the message is generated by the message generator or before the message is processed by the message receiver.

14. The device of claim 13, wherein the message modifier changes or drops at least one parameter of the generated message.

15. The device of claim 13, wherein the message modifier modifies a received message from the sender before the receiver processes the message.

16. The device of claim 13, wherein the message modifier modifies the message before the message is transmitted to an intended recipient.

17. The device of claim 13, wherein the message modifier includes a user interface portion that allows an individual to identify a type of message and at least one parameter in the message, the message modifier subsequently recognizing the type of message and modifying a message of the identified type according to the individual's preference.

18. The device of claim 13, wherein the message modifier comprises software.

19. The device of claim 13, wherein the message modifier identifies a message and determines if at least one criteria is satisfied that indicates that the identified message should be modified.
